(19) United States
(12) Patent Application Publication
(10) Pub. No.: US 2024/0181662 A1
(43) Pub. Date: Jun. 6, 2024

(54) SEALING ASSEMBLY AND ROBOT

(71) Applicant: ABB Schweiz AG, Baden (CH)

(72) Inventor: Xiaodong Cao, Shanghai (CN)

(21) Appl. No.: 18/553,918

(22) PCT Filed: Apr. 30, 2021
(86) PCT No.: PCT/CN2021/091395

§ 371 Date: Oct. 4, 2023

(51) Int. Cl. B25J 19/00; B25J 17/00; F16J 15/3204; F16J 15/3252

(52) U.S. Cl. CPC B25J 19/0083; B25J 17/00; F16J 15/3204; F16J 15/3252

(57) ABSTRACT

A sealing assembly which includes a rigid abutting sleeve hermetically and fixedly arranged on an end of a first component of a robot and axially extending into a ring-shaped groove formed at an end of a second component of the robot. The second component is coaxially rotatable relative to the first component. A rotatory seal is arranged in the ring-shaped groove and axially extending beyond or flush with an end surface of the second component. The rotatory seal includes a coupling portion and a deformable portion.

### FIELD

Embodiments of the present disclosure generally relate to a robot, and more specifically, to a sealing assembly for a robot.

### BACKGROUND

A sealing arrangement or a seal is a component or measure to prevent fluid or solid particles from leaking between adjacent bonding surfaces and to prevent external impurities such as dust and moisture from intruding into the equipment. Seals can be divided into static and dynamic seals. Static seals function against mating surfaces that have no relative motion between each other. Depending on the direction of compression, a static seal can be classified as either axial or radial. Dynamic seals exist when there is motion between surfaces. Typical motions include reciprocating, oscillating, and rotation.

For example, regarding a joint of a robot where there are relative rotations between components of the joint, a traditional radial sealing structure arranged between the components can provide a stable sealing solution for normal industry processes. With the development of industry, more robots have been applied to new areas such as food, pharmaceutical and health service industries. These industries require robots to meet stringent standards to ensure food and drug safety. When applied to the food and drug fields, seals of robots, especially seals for joints of robots, are usually specially designed to meet requirements of various standards.

### SUMMARY

Embodiments of the present disclosure provide a sealing assembly and a robot.

In a first aspect, a sealing assembly is provided. The sealing assembly comprises a rigid abutting sleeve hermetically and fixedly arranged on an end of a first component of a robot and axially extending into a ring-shaped groove formed at an end of a second component of the robot, the second component being coaxially rotatable relative to the first component; and a rotatory seal arranged in the ring-shaped groove and axially extending beyond or flush with an end surface of the second component, the rotatory seal comprising: a coupling portion; and a deformable portion extending radially inward from the coupling portion to abut against an outer surface of the rigid abutting sleeve at an angle exceeding a predetermined threshold.

With the sealing assembly, joints of robots can be cleaned more easily and have higher corrosion resistance. In this way, the robot can be used in the food and drug fields, which require high sealing performance and hygiene protection performance. Furthermore, the sealing assembly according to embodiments of the present disclosure has the advantages of fewer parts, easy processing, simple assembly and low tolerance requirements for workpieces.

In some embodiments, the sealing assembly further comprises a gasket arranged between and axially compressed by the first component and the rigid abutting sleeve. In this way, high level sealing between the first component and the rigid abutting sleeve can be achieved even if the elastic sealing ring does not have high manufacturing accuracy, thereby reducing the manufacturing costs of the elastic sealing ring.

In some embodiments, the rigid abutting sleeve is shaped to provide a smooth transition from the outer surface of the rigid abutting sleeve to the adjacent outer surface of the first component. In this way, joints of robots can be cleaned more easily.

In some embodiments, the rigid abutting sleeve comprises a sleeve body of a cylindrical shape or a cone shape and axially extending into the ring-shaped groove; and a radial protrusion radially protruding from the sleeve body and comprising at least one of a radial inward protrusion extending towards a central axis of the first component or a radial outward protrusion extending away from the central axis. This arrangement can facilitate the assembling of the rigid abutting sleeve on the first component.

In some embodiments, the gasket is arranged between the radial outward protrusion and the end of the first component, and the gasket is compressed to a predetermined level when the sleeve body is fixedly arranged in a stepped groove formed at the end of the first component. This arrangement can ensure that the gasket can be properly compressed, thereby improving the reliability and durability of the sealing assembly.

In some embodiments, a circumferential edge between an axial outer surface of the radial outward protrusion away from the end of the first component and an adjacent outer surface of the sleeve body are chamfered or rounded. This arrangement can facilitate the smooth transition from the radial outward protrusion to the sleeve body.

In some embodiments, the gasket is arranged between the sleeve body and a shoulder of the first component which is at a predetermined distance from an end surface of the first component, and the gasket is compressed to a predetermined level when the radial inward protrusion touches the end surface of the first component. This arrangement can ensure that the gasket can be properly compressed, thereby improving the reliability and durability of the sealing assembly.

In some embodiments, the rigid abutting sleeve is integrally formed. This arrangement can improve the strength of the rigid abutting sleeve and hygiene protection performance while increasing the integration of the robot.

In some embodiments, the deformable portion is tapered from the coupling portion to an end edge of the deformable portion in contact with the rigid abutting sleeve. In this way, the deformable portion can abut against the rigid abutting sleeve more reliably.

In some embodiments, the end edge of the deformable portion is rounded or chamfered to provide a smooth transition from an outer surface of the deformable portion to the adjacent outer surface of the rigid abutting sleeve. This arrangement can facilitate the smooth transition from the deformable portion to the rigid abutting sleeve.

In some embodiments, the sealing assembly further comprises a rigid mounting member arranged on the coupling portion to facilitate the coupling of the coupling portion to the ring-shaped groove.

In some embodiments, the rotatory seal is formed integrally with a self-lubricating and/or corrosion-resistant material.

In a second aspect, a robot is provided. The robot comprises at least one joint sealed by the sealing assembly as mentioned in the first aspect.

It is to be understood that the Summary is not intended to identify key or essential features of embodiments of the present disclosure, nor is it intended to be used to limit the scope of the present disclosure. Other features of the present disclosure will become easily comprehensible through the description below.

### BRIEF DESCRIPTION OF THE DRAWINGS

The above and other objectives, features and advantages of the present disclosure will become more apparent through more detailed depiction of example embodiments of the present disclosure in conjunction with the accompanying drawings, wherein in the example embodiments of the present disclosure, same reference numerals usually represent same components.

FIG. 1 shows a partial side sectional view of a joint of a robot according to embodiments of the present disclosure;

FIG. 2 shows a partial side sectional view of a joint of a robot according to embodiments of the present disclosure; and

FIG. 3 shows a partial side sectional view of a joint of a robot according to embodiments of the present disclosure.

Throughout the drawings, the same or similar reference symbols are used to indicate the same or similar elements.

### DETAILED DESCRIPTION

The present disclosure will now be discussed with reference to several example embodiments. It is to be understood these embodiments are discussed only for the purpose of enabling those persons of ordinary skill in the art to better understand and thus implement the present disclosure, rather than suggesting any limitations on the scope of the subject matter.

As used herein, the term “comprises” and its variants are to be read as open terms that mean “comprises, but is not limited to.” The term “based on” is to be read as “based at least in part on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be comprised below. A definition of a term is consistent throughout the description unless the context clearly indicates otherwise.

To ensure food and drug safety, many standards are used to restrict equipment, such as robots used in the food and drug fields. For instance, European Hygienic Engineering & Design Group (EHEDG) issues a standard called Hygienic Design Principles (Doc. 8). One article of the Hygienic Design Principles requires that the sealing surface of hygienic equipment such as robots used in the food and drug fields needs to be smooth or seamless and easy to clean to prevent bacteria or viruses from remaining on it. There are many similar standards in various countries or regions to ensure food and drug safety. For instance, a standard EN 1672-2 requires that fluid such as grease for lubrication sealed in a cavity must not be leaked to contaminate food or medicine being processed. NSF 51 sets requirements for the corrosion protection of seals.

Robots used in traditional regular industrial fields usually needs to be modified to meet the above requirements. Specifically, some robot joints use face type seal means, which is characterized in that end surfaces of two robot arms rotatable relative to each other are used as sealing surfaces. However, this approach requires high machining accuracy of the parts and a large number of parts, which results in high prices and high assembly requirements.

Some joints also employ radial seals to obtain a high sealing level, however, there are gaps or grooves on outer surfaces of the joints that are hard to clean. For example, a joint seal structure, as disclosed in WO2014087615A1 provides a sealing arrangement with gaps between the components. It is hard to clean dust or debris that enters these gaps, as a result, the robot cannot be used in the food and drug fields due to the difficulty of cleaning up. Some sealing structures have a risk of leaking harmful medium sealed therein.

Besides the above mentioned two approaches, some other joints use axial sealing means. For example, U.S. Pat. No. 7,878,088B2 discloses a sealing device provided to a joint section of a robot. The sealing device includes overlapped seal portions having a multi-stage configuration, provided for a driving mechanism incorporated into the joint section. However, this kind of sealing approach encounters a poor sealing effect. For example, the oil inside the joints is prone to leaking out, high pressure water can easily enter inside the joints, and grease is needed between the seals and the parts in contact with the seals.

In order to at least partially address the above and other potential problems, embodiments of the present disclosure provide a sealing assembly and a robot. With the sealing assembly, the robot, especially a joint of the robot using the sealing assembly becomes easy to clean, without risk of contaminating products such as food or medicine to be processed.

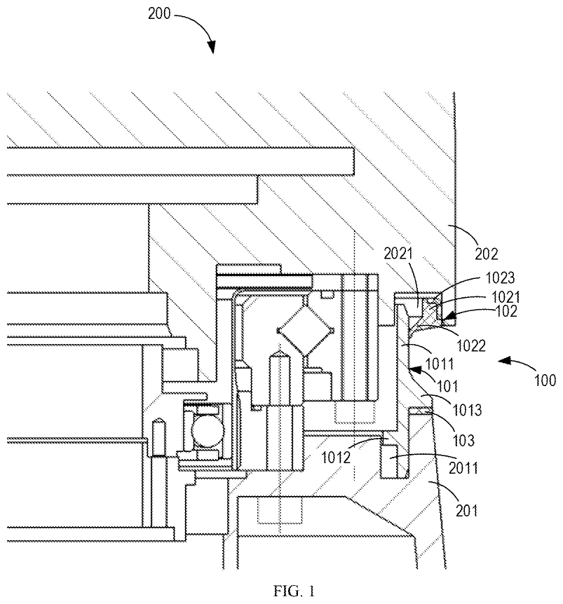

FIG. 1 shows a partial side sectional view of a joint of a robot 200 according to embodiments of the present disclosure. As shown in FIG. 1, the joint comprises two components, namely, a first component 201 and a second component 202, coaxially rotatable relative to each other. Such a joint is a kind of common joints used in robots 200. Outside the joint, an actuator or arm may be arranged, which can perform various actions through the joint.

It is to be understood that the joint as shown in FIG. 1 is only an example aiming to show an arrangement of the sealing assembly 100 relative to the joint, without suggesting any limitation as to the scope of the present disclosure. Actually, the structure or shape of the first or second component 202 can be of any suitable structure or shape. For example, in some embodiments, the first or second components 201, 202 may be of a shape matching other parts of the robot 200 or an integrated part of an arm or actuator.

As shown in FIG. 1, generally, the sealing assembly 100 according to embodiments of the present disclosure comprises a rigid abutting sleeve 101 and a rotatory seal 102. The rigid abutting sleeve 101 is hermetically and fixed arranged on an end of first component 201 and extends axially into a ring-shaped groove 2021 formed at end of the second component 202. The rotatory seal 102 is arranged in the ring-shaped groove 2021 of the second component 202.

It is to be understood that terms “first,” “second” herein aim to specify the different arms, without suggesting that the first component 201 and second component 202 have a specific order. Actually, for the sealing assembly 100 according to embodiments of the present disclosure, the first component 201 and second component 202 may be interchangeable. That is, the rigid abutting sleeve 101 may also be arranged on the second component 202 and the rotatory seal 102 may also be arranged on the first component 201. In the following, embodiments of the present disclosure will be discussed by taking the arrangements of the sealing assembly 100 as shown in FIGS. 1-3 as examples.

Arrangements other than those above are also similar, and will not be repeated in the following.

The rotatory seal 102 extends axially beyond or flush with an end surface of the second component 202 and comprises a coupling portion 1021 and a deformable portion 1022. The rotatory seal 102 is arranged in the ring-shaped groove 2021 via the coupling portion 1021. In some embodiments, to facilitate the coupling of the coupling portion 1021 to the ring-shaped groove 2021, a rigid mounting member 1023, e.g., made of metal material, may be arranged on the coupling portion 1021 and between the coupling portion 1021 and the ring-shaped groove 2021.

The deformable portion 1022 extends radially inward from the coupling portion 1021 to abut against an outer surface of the rigid abutting sleeve 101 at an angle exceeding a predetermined threshold. In some embodiments, the predetermined threshold may be 90° or an angle larger than 90°. In this way, a smooth transition can be provided through sealing assembly 100 from an outer surface of the first component 201 to an outer surface of the second component 202.

The term “smooth transition” means that between any two components with smooth transition, there is neither slot or groove nor tiny slot or groove with a size smaller than a predetermined size threshold. The size of a slot or groove smaller than the predetermined size threshold may make the joints difficult to clean. In addition, the term “smooth transition” also means that there are basically no sharp edges or angles smaller than a predetermined angle threshold between components with smooth transition.

Furthermore, the outer surface of the rigid abutting sleeve 101 is smooth to reduce the friction between the deformable portion 1022 and the rigid abutting sleeve 101. In some embodiments, lubricating grease may be needed between the deformable portion 1022 and the rigid abutting sleeve 101 to further reduce the friction therebetween.

FIGS. 1-3 show several examples of joints to which the sealing assembly 100 can be applied to illustrate that the sealing assembly 100 provides a smooth transition between the two mutual rotatable components of the joint. The examples shown in FIGS. 1, 2 and 3 are not exhaustive, and the sealing assembly 100 according to embodiments of the present disclosure can be applied to a joint having any suitable structure to provide a smooth transition between any two mutual rotatable components of the joint while ensuring the sealing performance. To this end, the shapes and sizes of the rigid abutting sleeve 101 and the rotatory seal 102 may be adjusted within the scope of the present disclosure to adapt to the different shapes and sizes of the coupled components, which will be discussed further in the following.

With the sealing assembly 100 arranged between the first component 201 and second component 202, as shown in FIG. 1, there is no slot, sharp edge or sharp angle that causes the joint to be hard to clean. In this way, the joint can be easily cleaned and a good cleaning effect is achieved while ensuring the sealing performance. Furthermore, the sealing assembly 100 according to embodiments of the present disclosure has the advantages of fewer parts, easy processing, simple assembly and low tolerance requirements for workpieces.

Furthermore, the reduced number and tolerance requirements of the workpieces of the sealing assembly 100 do not reduce the sealing performance. The deformable portion 1022 abutting against the outer surface of the rigid abutting sleeve 101 can withstand the impact of water at a certain pressure and temperature, to thereby meet most of the requirements as mentioned above.

In some embodiments, the deformable portion 1022 may be tapered from the coupling portion 1021 to an end edge of the deformable portion 1022 in contact with the rigid abutting sleeve 101. This arrangement can further ensure that the deformable portion 1022 can be pressed against the rigid abutting sleeve 101 with an appropriate and sufficient pressure, thereby providing a more reliable sealing performance.

In some embodiments, the end edge of the deformable portion 1022 may be rounded or chamfered to thereby provide a smooth transition from an outer surface of the deformable portion 1022 to the adjacent outer surface of the rigid abutting sleeve 101. In this way, the joint using the sealing assembly 100 can be cleaned more easily.

Furthermore, the rotatory seal 102 may be integrally formed of Polytetrafluoroethylene (PTFE). In this way, there is no need to apply lubricating grease where the deformable portion 1022 and the rigid abutting sleeve 101 are in contact with and rotatable relative to each other. As a result, the hygienic level of joints using this sealing assembly 100 can be further improved while ensuring the sealing performance.

It is to be understood that the above embodiments where rotatory seal 102 is integrally formed of Polytetrafluoroethylene (PTFE) are merely for illustrative purposes, without suggesting any limitation as to the scope of the present disclosure. The rotatory seal 102 may also be made of any suitable self-lubricating and/or corrosion-resistant material, such as rubber material, etc.

Furthermore, the rigid abutting sleeve 101 may be integrally made of any suitable rigid material as well. For example, in some embodiments, the rigid abutting sleeve 101 may be made of steel or aluminum to provide enough strength of the rigid abutting sleeve 101. It is to be understood that this is merely illustrative, without suggesting any limitation as to the scope of the present disclosure. As long as the required strength can be achieved, any suitable metal or non-metallic material is also possible to make the rigid abutting sleeve 101. For example, in some alternative embodiments, the rigid abutting sleeve 101 may also be made of plastic, ceramic or carbon fiber material for better corrosion resistance.

Moreover, the rigid abutting sleeve 101 may be arranged on the end of the first component 201 in any suitable way. For example, in some embodiments, the rigid abutting sleeve 101 may be arranged on the end of the first component 201 by thread connections. In some alternative embodiments, the rigid abutting sleeve 101 may also be arranged on the end of the first component 201 through interference fit, fastener connection, etc.

To further improve the sealing performance of the sealing assembly 100, in some embodiments, the sealing assembly 100 may further comprise a gasket 103 arranged between the first component 201 and the rigid abutting sleeve 101. The gasket 103 can be axially compressed by the first component 201 and the rigid abutting sleeve 101. The gasket 103 may have a ring shape and be made of any suitable elastic and corrosion-resistant material, such as rubber, silicone, etc.

In some embodiments, the rigid abutting sleeve 101 may be shaped to provide a smooth transition from the outer surface of the rigid abutting sleeve 101 to the adjacent outer surface of the first component 201. Depending on the shape and configuration of the first component 201 to be arranged, the rigid abutting sleeve 101 may have any appropriate shape and the gasket 103 may be arranged at any appropriate position between the first component 201 and the rigid abutting sleeve 101.

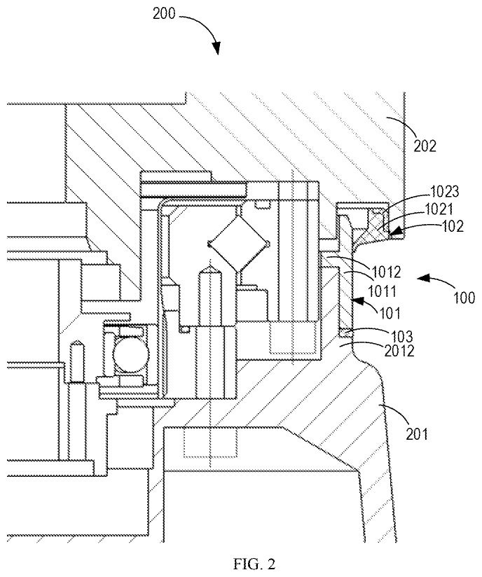

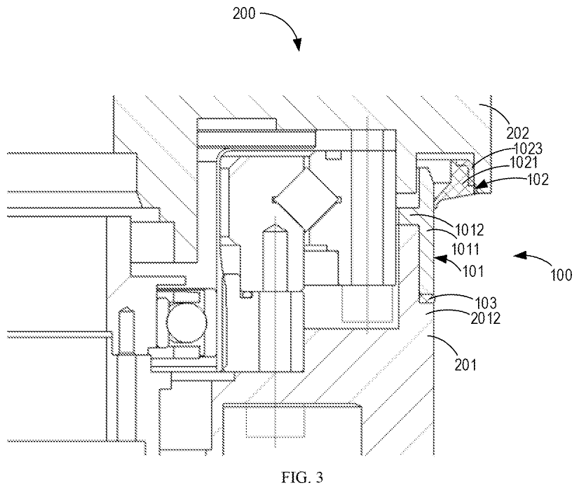

To this end, in some embodiments, the rigid abutting sleeve 101 may comprise a sleeve body 1011 of a cylindrical shape or a cone shape and a radial protrusion radially protruding from the sleeve body 1011. The sleeve body 1011 axially extends into the ring-shaped groove 2021 without contacting inner surfaces of the ring-shaped groove 2021. According to different protruding directions, the radial protrusion may comprise a radial inward protrusion 1012 extending towards a central axis of the first component 201 and/or a radial outward protrusion 1013 extending away from the central axis. For example, for the shape and configuration of the first component 201 as shown in FIG. 1, the radial protrusion comprises the radial inward protrusion 1012 and the radial outward protrusion 1013. For the first components 201 as shown in FIGS. 2 and 3, the radial protrusion merely comprises the radial inward protrusion 1012.

Specifically, for the shape and configuration of the first component 201 as shown in FIG. 1, in some embodiments, the gasket 103 may be arranged between the radial outward protrusion 1013 and the end of the first component 201. Furthermore, the sleeve body 1011 is fixedly arranged in a stepped groove 2011 formed at the end of the first component 201. The sleeve body 1011 is sized to, when the sleeve body 1011 is fixedly arranged in the stepped groove 2011, the gasket 103 is compressed to a predetermined level. The predetermined level herein means that the gasket 103 is compressed so that it can at least withstand the impact of water at a predetermined pressure and temperature.

To ensure the predetermined level while preventing excessive compression, in some embodiments, sleeve body 1011 may be sized to, when the sleeve body 1011 touches a bottom end of the stepped groove 2011, the gasket 103 is compressed to the predetermined level. That is, the bottom end of the stepped groove 2011 provides a stop for the sleeve body 1011. In this way, a user only needs to simply fix the sleeve body 101 in position, i.e., to a position where the sleeve body 1011 touches a bottom end of the stepped groove 2011. As a result, the assembling of the rigid abutting sleeve 101 can be simplified without worrying about the gasket 103 being over-compressed.

To provide a smooth transition, the radial outer surface of the radial outward protrusion 1013 may be axially flush with the outer surfaces of the first component 201 and the gasket 103. Furthermore, a circumferential edge between an axial outer surface of the radial outward protrusion 1013 away from the first component 201 and the adjacent outer surface of the sleeve body 1011 is chamfered or rounded to provide a smooth transition therebetween, as shown in FIG. 1.

In some embodiments, as shown in FIGS. 2 and 3, the gasket 103 may also be arranged between the sleeve body 1011 and a shoulder 2012 of the first component 201. The shoulder 2012 of the first component 201 is at a predetermined distance from an end surface of the first component 201. Or it can be said that the part of the end of the first component 201 from the shoulder 2012 to the end surface is reduced in diameter. In this event, the radial inward protrusion 1012 of the rigid abutting sleeve 101 is adjacent to the end surface of the first component 201. To ensure the gasket 103 is to be properly compressed, the rigid abutting sleeve 101 is sized to, when the radial inward protrusion 1012 touches the end surface of the first component 201, the gasket 103 is compressed to a predetermined level.

As shown in FIG. 2, there may be a smooth transition between the radially outer surface of the sleeve body 1011 and outer surface of the first component 201. Alternatively, in some embodiments, as shown in FIG. 3, the radially outer surface of the sleeve body 1011 may be axially flush with outer surfaces of the gasket 103 and the first component 201. In this way, the joint with the sealing assembly 100 may be cleaned more easily.

According to another aspect of the present disclosure, a robot 200 is provided. The robot 200 comprises at least one joint sealed by the sealing assembly 100 as mentioned above. With the sealing assembly 100, the joints can be cleaned more easily and have higher corrosion resistance. In this way, the robot 200 can be used in food and drug fields, which require high sealing performance and hygiene protection performance. Furthermore, the joint with the sealing assembly 100 can be cleaned with any suitable cleaning means such as high pressure water cleaning.

It should be appreciated that the above detailed embodiments of the present disclosure are only to exemplify or explain principles of the present disclosure and not to limit the present disclosure. Therefore, any modifications, equivalent alternatives and improvements, etc. without departing from the spirit and scope of the present disclosure shall be comprised in the scope of protection of the present disclosure. Meanwhile, appended claims of the present disclosure aim to cover all the variations and modifications falling under the scope and boundary of the claims or equivalents of the scope and boundary.

1. A sealing assembly comprising:
a rigid abutting sleeve hermetically and fixedly arranged on an end of a first component of a robot and axially extending into a ring-shaped groove formed at an end of a second component of the robot, the second component being coaxially rotatable relative to the first component; and
a rotatory seal arranged in the ring-shaped groove and axially extending beyond or flush with an end surface of the second component, the rotatory seal comprising:
a coupling portion; and
a deformable portion extending radially inward from the coupling portion to abut against an outer surface of the rigid abutting sleeve at an angle exceeding a predetermined threshold.

2. The sealing assembly of claim 1, further comprising:
a gasket arranged between and axially compressed by the first component and the rigid abutting sleeve.

3. The sealing assembly of claim 2, wherein the rigid abutting sleeve is shaped to provide a smooth transition from the outer surface of the rigid abutting sleeve to the adjacent outer surface of the first component.

4. The sealing assembly of claim 3, wherein the rigid abutting sleeve comprises:
a sleeve body of a cylindrical shape or a cone shape and axially extending into the ring-shaped groove; and
a radial protrusion radially protruding from the sleeve body and comprising at least one of a radial inward protrusion extending towards a central axis of the first component or a radial outward protrusion extending away from the central axis.

5. The sealing assembly of claim 4, wherein the gasket is arranged between the radial outward protrusion and the end of the first component, and
the gasket is compressed to a predetermined level when the sleeve body is fixedly arranged in a stepped groove formed at the end of the first component.

6. The sealing assembly of claim 5, wherein a circumferential edge between an axial outer surface of the radial outward protrusion away from the end of the first component and an adjacent outer surface of the sleeve body are chamfered or rounded.

7. The sealing assembly of claim 4, wherein the gasket is arranged between the sleeve body and a shoulder of the first component which is at a predetermined distance from an end surface of the first component, and
the gasket is compressed to a predetermined level when the radial inward protrusion touches the end surface of the first component.

8. The sealing assembly of claim 4, wherein the rigid abutting sleeve is integrally formed.

9. The sealing assembly of claim 1, wherein the deformable portion is tapered from the coupling portion to an end edge of the deformable portion in contact with the rigid abutting sleeve.

10. The sealing assembly of claim 9, wherein the end edge of the deformable portion is rounded or chamfered to provide a smooth transition from an outer surface of the deformable portion to the adjacent outer surface of the rigid abutting sleeve.

11. The sealing assembly of claim 1, further comprising:
a rigid mounting member arranged on the coupling portion to facilitate the coupling of the coupling portion to the ring-shaped groove.

12. The sealing assembly of claim 1, wherein the rotatory seal is formed integrally with a self-lubricating and/or corrosion-resistant material.

13. A robot, comprising at least one joint sealed by the sealing assembly of claim 1.

14. The robot of claim 13, wherein the sealing assembly further comprises a gasket arranged between and axially compressed by the first component and the rigid abutting sleeve.

15. The robot of claim 14, wherein the rigid abutting sleeve is shaped to provide a smooth transition from the outer surface of the rigid abutting sleeve to the adjacent outer surface of the first component.

16. The robot of claim 15, wherein the rigid abutting sleeve comprises:
a sleeve body of a cylindrical shape or a cone shape and axially extending into the ring-shaped groove; and
a radial protrusion radially protruding from the sleeve body (and comprising at least one of a radial inward protrusion extending towards a central axis of the first component or a radial outward protrusion extending away from the central axis.

17. The robot of claim 13, wherein the deformable portion is tapered from the coupling portion to an end edge of the deformable portion in contact with the rigid abutting sleeve.

18. The robot of claim 17, wherein the end edge of the deformable portion is rounded or chamfered to provide a smooth transition from an outer surface of the deformable portion to the adjacent outer surface of the rigid abutting sleeve.

19. The robot of claim 13, wherein the sealing assembly further comprises:
a rigid mounting member arranged on the coupling portion to facilitate the coupling of the coupling portion to the ring-shaped groove.

20. The robot of claim 13, wherein the rotatory seal is formed integrally with a self-lubricating and/or corrosion-resistant material.
